(19) United States
(12) Patent Application Publication
(10) Pub. No.: US 2007/0141263 A1
(43) Pub. Date: Jun. 21, 2007

(54) Process and an apparatus for coating printed circuit boards with laser-structurable, thermally curable solder stop lacquers and electroresists

(76) Inventor: Hans-Jurgen Schaefer, Duisburg (DE)

Correspondence Address: BUCHANAN INGERSOLL & ROONEY PC, P.O. BOX 1404, ALEXANDRIA, VA, 22313-1404, US

(21) Appl. No.: 10/531,394

(22) PCT Filed: Oct. 14, 2003
(86) PCT No.: PCT/EP03/11369

§ 371 Date: Jul. 25, 2006

(30) Foreign Application Priority Data
Oct. 14, 2002 (DE) 102 47 861.9
Oct. 29, 2002 (DE) 102 50 485.7
Nov. 12, 2002 (DE) 102 52 897.7
Jan. 5, 2003 (DE) 103 00 344.4

(51) Int. Cl. B05D 5/12; B05D 3/12; B05C 1/00; B05C 1/06

(52) U.S. Cl. 427/355; 427/96.1; 118/249; 118/261

(57) ABSTRACT

Disclosed are a method and a device for coating printed boards (1) with solder stop lacquers and galvanoresists that can be laser-structured and thermally hardened. The device used for carrying out said method comprises at least one roller-type coating plant (2) with an application roller (4), a dosing roller (5) that embodies a dosing gap along with the application roller (4), a storage container (6) for the solder stop lacquer or galvanoresist, which is disposed above the roller-type coating plant (2), means for conveying the printed boards (7), means for drying the solder stop lacquer (11), and an apparatus (13) for turning the coated printed boards. Said roller-type coating plant (2) is provided with only one coating unit for coating the bottom side of the printed boards.

### TECHNICAL FIELD

The invention relates to a process and an apparatus for coating printed circuit boards with laser-structurable, thermally curable solder stop lacquers and electroresists.

### BACKGROUND ART

Printed circuit boards are coated with solder stop lacquers, specifically with photosensitive solder stop lacquers, in order to protect the electric conductors and in order to leave only the drill holes and the soldering pads to be soldered free for the soldering tin. While screenprinting processes have been sufficient until 1975, photosensitive solder stop lacquers have achieved acceptance in that field since that time. The precision required by circuits becoming more and more complex could only be made sure by the process of photostructuring. These lacquers were preferably applied on one side by a curtain cast process. This is described in the European patent application EP 0 002 040 A1.

This application technology leads to several problems. These are especially the covering of edge areas of high fine conductors with a width and a height of 100 μm. The lacquers applied with a viscosity of 500 to 1200 mPas flow off the edges of the conductor especially during drying because of the related reduction in viscosity. This problem was solved by using volatile solvents and high thixotropy via addition of fillers. The coated printed circuit boards were initially air-dried in a paternoster-type furnace at low temperatures, whereby the lacquer is dried onto the conductor. Subsequently, the actual drying by hot air takes place.

The problem of coating high conductors was also particularly solved by spray coating. According to all these coating processes, the drilling holes are also coated, however. The lacquer flown therein is solved out after photostructuring in a developing bath. This, and the solder pads being developed free, leads to a significant waste water contamination. The quality of the lacquers has particularly been deteriorated by the alkaline developing baths because these accordingly had to provide corresponding carboxyl groups deteriorating the affinity to humidity. The acrylates required by the photostructuring process affect the softening range of the solder stop lacquer, this being disadvantageous particularly during soldering with lead-free solder material at higher soldering temperatures.

This generation of solder stop lacquers is faced with new problems because of the further proceeding miniaturisation. Thereby especially the uncertainty of the development has negative effects. All these problems can be solved using a laser structurable solder stop lacquer. Thereby only the soldering pads and the remaining rings of the drill holes are set free from the lacquer by means of a CO₂ laser. A developing process is not required. Thus, no polymeric waste occurs. The laser can be positioned very exactly. Problems such as offset of the film cannot occur. The use of a non-photosensitive, thermally curable solder stop lacquer currently fails, because there is no application process available being capable to secure lacquer-free drill holes.

European patent application EP 0 766 908 describes a roll coating process for coating opposite sides with a photopolymerisable coating agent for producing multi chip modules, wherein the metering roles can be heating to 25 to 60° C. and the applicator rolls can be cooled to 5 to 20° C. The heating of the lacquer leads to evaporation and to drying of the lacquer layer not transferred onto the rubber surface of the applicator roll. Cooling leads to condensation. The coating of the edged areas of the conductor achieved at a height of the conductor of 50 μm and a thickness of the lacquer layer of 50 μm was 13 μm. The drill holes were not lacquer-free. The coating viscosity is as high as 20000 to 100000 mPas, thereby only being capable to be processed with patterned rolls at a thickness of the coating from 50 to 200 μm. The coating speed between 5 and 20 m per minute is too high for a coating with solder stop lacquers because a good coating of the edge areas cannot be achieved.

This high coating speed is also described in German patent application DE 101 31 027 A1 (titled: Process and apparatus for high speed coating of wood/plastic and metal surfaces). Thereby powder coatings curable by irradiation are preferably supplied from a storage container for powder coatings via a melt roll. This is not practicable with solely thermally curing lacquers because curing reactions and agglutinations occur in this case. In order to coat the bottom side a melt roll is dipped into a storage container for powder coatings without metering. In case of thermally curing lacquers this leads to a hardening of the stored material.

The same applies for the process described in European patent specification EP 0 698 233 B1 describing the application of a coating agent curable by irradiation from the melted material. None of the known processes is capable to fulfil the object of the present invention. They exclusively relate to lacquer systems curable by irradiation. Edge areas free of lacquer that are necessary to transport the printed circuit boards also cannot be achieved. Available solder stop lacquers contain mineral fillers to increase the viscosity, particularly in order to avoid the lacquers running off the side walls of the conductor. These mineral fillers are usually contained in the solder stop lacquers in a weight portion from 20 to 50 wt.-%. If these available solder stop lacquers are structurized by means of a laser, a residue of ash remains on the solder pads, which assembles in a mushroom-like form. This inhibits a clean soldering, the more so as cleaning is difficult.

Drill holes free of lacquer also cannot be guaranteed with the current application process.

The object of the present invention is to solve the above mentioned problems occurring in the art of coating printed circuit boards. A main object of the present invention is to provide a preferably thermally curable solder stop lacquer and electroresist as well as to provide a process and an apparatus enabling a laser structuring without residues and providing a good coating of the edge areas in case of thin and high conductors at a low thickness of the lacquer layer, a clean, closed lacquer surface and, at the same time, drill holes and edges of the printed circuit boards.

The subject of the invention is an apparatus for coating printed circuit boards with a solder stop lacquer or a electroresist, comprising at least one roll coating apparatus having an upper rubberised lead roll, a lower rubberised applicator roll, a storage container for the solder stop lacquer or the electroresist arranged above the roll coating apparatus, means to transport the printed circuit boards, means to dry the solder stop lacquer and a device for turning the coated printed circuit board, said roll coating apparatus having only one coating unit to coat the bottom side of the printed circuit boards.

Preferred embodiments of the apparatus according to the present invention are subject-matter of claims 2 to 6.

The invention further relates to a process for coating printed circuit boards with a solder stop lacquer or an electroresist, comprising the following steps:
(i) supplying a printed circuit board to a roll coating apparatus having only one coating unit to coat the bottom side of the printed circuit board,
(ii) metering the solder stop lacquer or the electroresist having a viscosity of 4000-12000 mPas at 25° C. or a powder coating,
(iii) applying the lacquer onto the bottom side of the printed circuit board,
(iv) drying the coated printed circuit board for a period and at a temperature sufficient to reduce the viscosity of the lacquer below 300 mPas or reducing the viscosity of the powder coating below 500 mPas, hardening the lacquer and rendering the lacquer non-tacky, and
(v) turning the printed circuit board and performing the steps (i) to (iv) in the same roll coating apparatus or in a further one.

Preferred embodiments of the process according to the present invention are subject-matter of claims 8 to 10.

Finally, the present invention relates to a solder stop lacquer and an electroresist structurable via laser, having a solid content of 50-100 wt.-% and a viscosity of 5000-15000 mPas at 25° C.

Preferred embodiments of this solder stop lacquer or electroresist are subject-matter of claims 13 to 17.

### BRIEF DESCRIPTION OF THE DRAWINGS

FIG. 1 shows the apparatus of the present invention schematically.

FIG. 2 shows a further embodiment of the apparatus according to the present invention for the use of powder coatings.

FIG. 3 schematically shows a printed circuit board coated by a prior art process.

FIG. 4 shows a printed circuit board coated by the process according to the present invention.

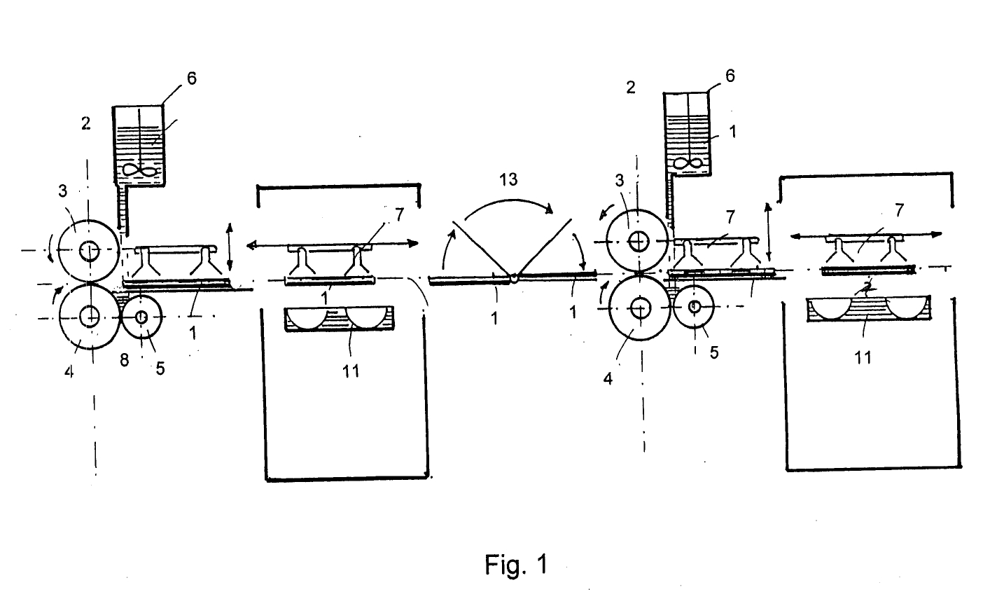

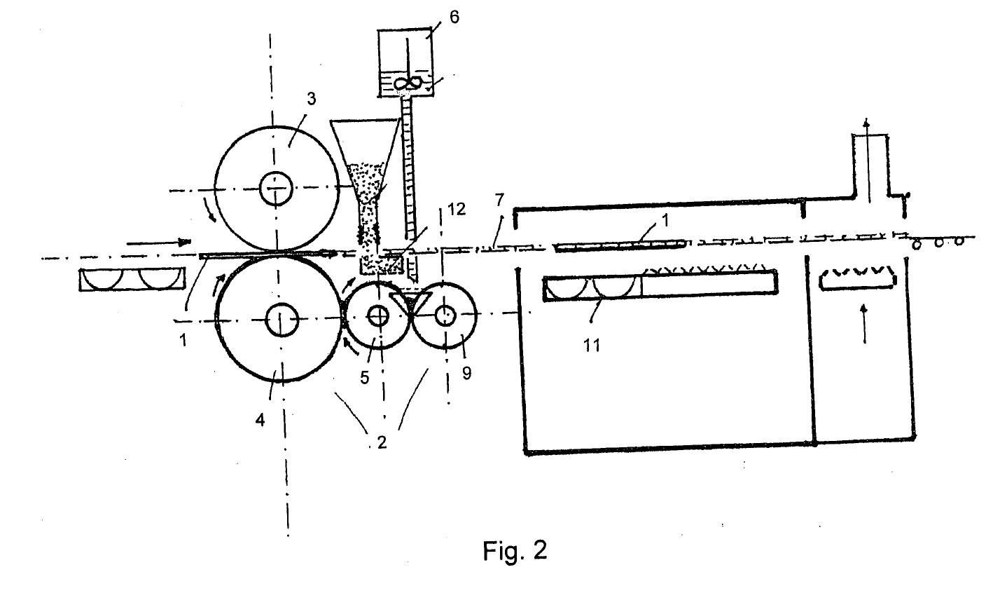

The reference signs used therein are denoting the following:
(1) printed circuit board
(2) roll coating apparatus
(3) rubberised lead roll
(4) rubberised applicator roll
(5) metering roll
(6) storage container
(7) means to transport the printed circuit boards
(8) coating knife
(9) metering roll
(10) copper conductor
(11) means to transport the solder stop lacquer
(12) screen case
(13) turning device
(14) coating of the edge areas of the conductor

### DETAILED DESCRIPTION OF THE INVENTION

In the following, the present invention is explained in more detail. The application of the lacquer can be carried out using processes known in the art, as long as the coating apparatus used thereby has only one coating unit to coat the bottom side of the substrates.

In case of using an apparatus according to claim 1 for example a solder stop lacquer having a viscosity of preferably 5000 to 15000 mPas at 25° C. and a solids content of 50 to 100%, being both thermally curable and curable by irradiation and containing preferably no or only small amounts of mineral fillers is supplied to a first roll coating apparatus (2) together with a printed circuit board (1) provided with conductors and drill holes to incorporate wired components, the roll coating apparatus (2) consisting of an upper rubberised guide roll (3), a lower rubberised applicator roll (4) and a metering roll (5) forming a metering gap together with the applicator roll (4). A wedge-shaped coating knife (8) can optionally be arranged between the applicator roll (4) and the metering roll (5) for rendering the edge areas of the printed circuit boards free of lacquer. A highly viscous solder stop lacquer is metered between the metering roll (5) and the applicator roll (4) from a storage container (6) arranged above the roll coating apparatus (2). The solder stop lacquer having a viscosity of preferably 5000 to 15000 mPas is applied on the bottom side of the printed circuit board (1) preferably at a speed of 1 to 4 m/min at a thickness of the layer of preferably 10 to 70 μm over the smooth (Rz=5 μm to 10 μm) and supple (20 to 40 Shore A) rubber surface.

In the case of this highly viscous coating only a part of the lacquer layer located on the applicator roll is transferred due to the high adhesive strength of the lacquer on the rubber coating. A requirement for the transfer of the lacquer is the adhesive strength on the surface of the printed circuit board to be coated. Since this adhesive strength exhibits the highest values for the copper conductors (10), the thickest lacquer layer is consequently applied there. The drill holes are not capable for forming an adhesive area and therefore no lacquer is transferred there. According to state of the art roll coating processes, the lacquer is applied by means of a grooved rubber coating in such a way that the lacquer is pressed out of the grooves, whereby lacquer is also pressed into the drill holes. In the process according to the present invention the coating occurs independently from the nature of surface to be coated. Hence, the thus applied solder stop lacquer excellently covers the conductors and maintains the drill holes and the edge areas of the printed circuit boards free of lacquer, so that a good soldering of the wired components and a transport of the printed circuit board into the drier is ensured. A damage of the rubber surface by cuts of the high conductors is prevented by the rubber coating according to the present invention in connection with the high viscosity of the coating.

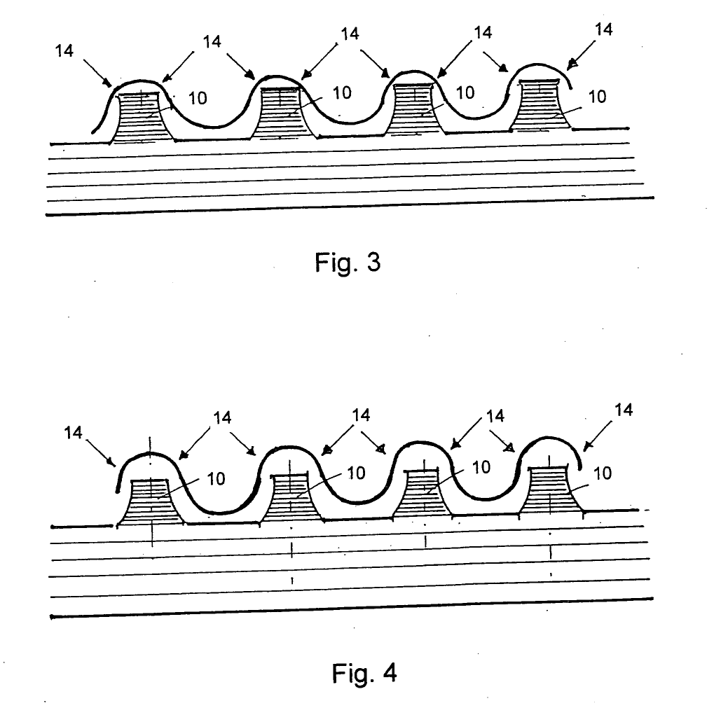

After this coating, the printed circuit board (1) is transported via means to transport the printed circuit board (7), such as a chain transport means with transport clamps, into a drier, such as an infrared drier, which is only fitted under the transport paths with drying means, such as an IR-irradiator (11). These are equipped with irradiators in the medium wave length range of 2 to 4 μm. In contrast to the heretofore used evaporation paths in a paternoster-type furnace, in which the lacquer is to dry without a reduction in viscosity, so that it does not run off the edge areas of the conductor due to the reduction in viscosity, the process according to the present invention aims at the contrary effect. The viscosity of the lacquer shall be reduced as fast as possible from its initial value of 5000 to 15000 mPas to below 500 mPas. Hereby the before corrugated lacquer surface smoothes and the lacquer flows up the side walls of the conductor. The absence of mineral fillers favours this flow process. The temperature of the lacquer should be brought up to 100 to 120° C. within 10 to 60 seconds. Dropping off is avoided-by the starting drying and the corresponding increase in viscosity. The drill holes and the edge areas remain free of lacquer. The subsequently starting drying results in a hardening of the lacquer. After being rendered non-tacky by drying and curing the printed circuit board (1) is turned in a turning means (13) and either coated for a second time using the same apparatus or supplied to a second roll coating apparatus constructed in the same way. As can be seen from FIG. 3, the conductors (14) usually have a coating of the edges from 5 to 10 μm in case of a thickness of the lacquer layer of 30 μm. Using the process according to the present invention a coating of the edges of the conductors (14) of more than 10 μm is achieved as illustrated in FIG. 4.

According to the present invention, this is achieved by incorporating a portion of a non-volatile solvent with a boiling point of more than 120° C. in an amount of 5 to 20 wt.-% and by the absence of mineral fillers. In case of using a powdery solder stop lacquer, this is achieved by reducing the viscosity below 500 mPas. This absence of mineral fillers also enables a structuring via laser without mushroom-like residues of ash on the copper surfaces.

According to a further embodiment, the apparatus for carrying out the process according to the present invention exhibits a further metering roll (9). Between the metering rolls (5) and (9) the highly viscous solder stop lacquer is metered from a storage container (6) arranged above the roll coating apparatus (2). In case of using a thermally curable powdery solder stop lacquer the lacquer is applied via a screen case (12) onto the metering roll (5) rotating in opposite direction compared to the applicator roll (4). The metering roll (5) absorbs the lacquer remaining on the applicator roll (4) on which the powdery solder stop lacquer is dispersed subsequently. Thus, an initial curing is avoided and the roll application of thermally curable powdery solder stop lacquers is enabled. After adjusting the thickness of the layer by means of the metering rolls (5) and (9) the absence of lacquer on the edges is achieved by a film having a thickness of about 30-150 μm which is stuck onto the fixed metering roll (9), the coating area being left free. Subsequently, this lacquer is transferred to the smooth (Rz=5-10 μm) and supple (20 to 40 Shore A) rubber surface of the applicator roll (4) by the metering roll (5) running in opposite direction and applied with a viscosity of preferably 5000 to 15000 mPas and with a speed of 1 to 4 m/min in a thickness of the layer of 20 to 70 μm onto the bottom side of the printed circuit board (1). In case of using a thermally curable, powdery solder stop lacquer for the coating, each roll and the printed circuit board to be coated is heated to a temperature with which the required viscosity of the coating is achieved. The present invention is explained in more detail by the following examples:

### EXAMPLE 1

Printed circuit board 300×420×1.5 mm Type FR 4 according to NEMA height of the conductor max. 100 μm width of the conductor 150 μm

Solder stop lacquer: Probimer 65 Fa. Vantico AG 100 parts by weight+5 parts by weight γ-butyrolacton

Roll coating apparatus: RC Fa. Bürkle rubber coating:

100 mm, 30 Shore A, Rz 5 μm

Gap width: 100 μm

Wet application: 50 μm

Speed: 2 m/min

IR-irradiator: first irradiator having a wave length of 2 μm, second irradiator having a wave length of 4 μm

Circulating air temperature: 120° C.

Dryer length: 4 m

Result:

Thickness of the dry film: 30 μm

Coating of the edge areas in case of a height of the conductor of 100 μm: 11 μm

Drill holes diameter 300 to 1000 μm: free of lacquer

### EXAMPLE 2

Printed circuit board (2) 300×420×1.5 mm Type FR 4 according to NEMA height of the conductor max. 100 μm width of the conductor 150 μm

Solder stop lacquer (1): 125 parts by weight Rütapox VE 3746 80 wt.-% in methylglycol, Fa. Bakelite AG
0.5 parts by weight 2-ethyl-4-methylimidazole, Fa. BASF
viscosity: 9500 mPas at 25° C.
TG after curing for 1 hour at 160° C.: 155° C.

Roll coating apparatus: RC Fa. Bürkle, rubber coating:

100 mm, hardness: 30 Shore A, Rz 5 μm

Gap width: 100 μm

Wet application: 50 μm

Speed: 2 m/min

IR-irradiator: first irradiator having a wave length of 2 μm, second irradiator having a wave length of 4 μm

Circulating air temperature: 120° C.

Dryer length: 4 m

Curing at 160° C. for 1 hour

Result coating:

Thickness of the dry film: 30 μm

Coating of the edge area in case of a height of the conductor of 100 μm: 11 μm

Drill holes diameter 300 to 1000 μm: free of lacquer

Result structuring via laser:

CO₂ laser: soldering pads free of ash residues

Result soldering:

Drill holes and soldering pads cleanly wetted with solder material

### EXAMPLE 3

Printed circuit board 300×420×1.5 mm Type FR 4 according to NEMA height of the conductor max. 100 μm width of the conductor 100 μm

Solder stop lacquer

| | | |
|---|---|---|
| 80.0 | parts by weight | EPOSID VP 868-2, 70 wt.-% Duro-plast-Chemie |
| 19.5 | parts by weight | HAT 9490 Kresolnovolak 100 wt.-% Fa. Vantico |
| 0.5 | parts by weight | 2-ethyl-4-methylimidazole Fa. BASF |
| 100.0 | parts by weight | 75 wt.-% |

Viscosity: 7500 mPas at 25° C. TG after curing for 1 hour at 160° C.: 150° C.

Roll coating apparatus: RC Fa. Robert Bürkle GmbH Freudenstadt

Rubber coating: 100 mm

Hardness: 30 Shore A, Rz 5 μm

Gap width: 120 μm

Wet application: 50 μm

Transferred amount: 42 vol.-%

Speed: 2 m/min

IR-irradiator: first irradiator having a wave length of 2 μm, second irradiator having a wave length of 4 μm

Circulating air temperature: 120° C.

Dryer length: 4 m

Result:

Thickness of the dry film: 30 μm

Coating of the edge area in case of a height of the conductor of 100 μm: 11 μm

Drill holes diameter 300 to 1000 μm: free of lacquer Edge areas of the printed circuit board: 5 mm free of lacquer

Result structuring via laser:

CO₂ laser: soldering pads free of ash residues

Combustion gases: halogen-free

Result soldering:

Drill holes and soldering pads cleanly wetted with solder material

### EXAMPLE 4

Printed circuit board 300×420×1.5 mm Type FR 4 according to NEMA, height of the conductor max. 100 μm, width of the conductor 100 μm

Solder stop lacquer

| | | |
|---|---|---|
| 80.0 | parts by weight | EPOSID VP 868-2, 70 wt.-% . Duro-plast- |
| | | Chemie |
| 19.5 | parts by weight | HAT 9490 Kresolnovolak 100 wt.-% Fa. |
| | | Vantico |
| 0.5 | parts by weight | 2-ethyl-4-methylimidazole Fa. BASF |
| 100.0 | parts by weight | 75 wt.-% |

Viscosity: 7500 m Pas at 25° C.

Roll coating apparatus: RC Fa. Robert Bürkle GmbH Freudenstadt

Rubber coating thickness: 100 mm

Hardness: 30 Shore A, Rz 5 μm

Gap width between the metering rolls (5) and (9): 120 μm

Wet application: 50 μm

Transferred amount: 42 vol.-%

Teflon film on the metering roll (9), open area at the right edge: 410 mm

Speed: 2 m/min

IR-irradiator: first irradiator having a wave length of 2 μm, second irradiator having a wave length of 4 μm

Circulating air temperature: 120° C.

Dryer length: 4 m

### EXAMPLE 5

Printed circuit board 300×420×1.5 mm Type FR 4 according to NEMA height of the conductor max. 100 μm width of the conductor 100 μm

Powdery solder stop lacquer:

| | | |
|---|---|---|
| 95.00 | parts by weight | epoxy resin DER 671 Fa. Dow Chemical |
| 4.5 | parts by weight | dicyandiamide |
| 0.5 | parts by weight | 2-methylimidazole Fa. BASF |
| 100.0 | parts by weight | powdery solder stop lacquer |

Melting region: 65-78° C.

Viscosity: 14.00 m Pas at 110° C.

Grain size: 10-20 μm

TG after curing for 1 hour at 160° C.: 160° C.

Roll coating apparatus: H RC Fa. Robert Bürkle GmbH Freudenstadt

Rubber coating: 10 mm

Hardness: 30 Shore A, Rz 5 μm

Temperature of the applicator roll (4) and the metering rolls (5) and (9): 110° C.

Temperature of the printed circuit board: 110° C.

Teflon film on metering roll (9), open area at the right edge: 410 mm

Gap width between the metering roll (5) and (9): 50 μm

Dry application: 30 μm

Transferred amount: 60 vol.-%

Speed: 3 m/min

IR-irradiator: first irradiator having a wave length of 2 μm, second irradiator having a wave length of 4 μm

Circulating air temperature: 140° C.

Dryer length: 4 m

Result:

First coating:

Thickness of the dry film: 30 μm

Coating of the edge areas in case of a height of the conductor of 100 μm: 11 μm

Drill holes diameter 300 to 1000 μm: free of lacquer edges of the printed circuit board: 5 mm free of lacquer

Result:

Second coating:

Thickness of the dry film: 30 μm

Coating of the edge areas in case of a height of the conductor of 100 μm: 12 μm

Drill holes diameter 300 to 1000 μm: free of lacquer Edges of the printed circuit boards: 5 mm free of lacquer

Result structuring via laser:

CO₂ laser: soldering pads free of ash residues

Combustion gases: halogen-free

Result soldering:

Drill holes and soldering pads cleanly wetted with soldering material

1. An apparatus for coating printed circuit boards (1) with a solder stop lacquer or an electroresist, comprising at least one roll coating apparatus (2) having an upper rubberised guide roll (3), a lower rubberised applicator roll (4), a metering roll (5) forming a metering gap together with the applicator roll (4), a storage container (6) for the solder stop lacquer or the electroresist arranged above the roll coating apparatus (2), means to transport the printed circuit boards (7), means to dry the solder stop lacquer (11) and a device for turning the coated printed circuit boards, said roll coating apparatus (2) having only a coating unit for coating the bottom side of the printed circuit board.

2. An apparatus according to claim 1, wherein the applicator roll (4) has a hardness of 20 to 40 Shore A and a roughness R_{z} of 5 to 10 μm.

3. An apparatus according to claim 1, wherein the apparatus further comprises a wedge shaped coating knife (8) between the applicator roll (4) and the metering roll (5).

4. An apparatus according to claim 1, wherein the apparatus further comprises a second metering roll (9) forming a metering gap with the first metering roll (5), above which the storage container (6) or a screen case (12) in case of powder coatings is located.

5. An apparatus according to claim 1, wherein the metering rolls (5, 9) are heatable.

6. An apparatus according to claim 4, wherein the second metering roll (9) is a fixed metering roll being coated with a plastic film in such a way that the desired coating areas can be set free by peeling off the film.

7. A process for coating printed circuit boards (1) with a solder stop lacquer or an electroresist, comprising the following steps:
(i) supplying the printed circuit board (1) to a roll coating apparatus having only a coating unit for coating the bottom side of the substrate,
(ii) metering the solder stop lacquer or electroresist having a viscosity of 4000-15000 mPas at 25° C. or metering a powder coating,
(iii) applying the lacquer on the bottom side of the printed circuit board (1),
(iv) drying the coated printed circuit board (1) for a period and at a temperature sufficient to reduce the viscosity of the lacquer below 300 mPas or to reduce the viscosity of the powder coating under 500 mPas, to harden the lacquer and to render it non-tacky, and
(v) turning the printed circuit board and performing the steps (i) to (iv) in the same roll coating apparatus or in a further one.

8. A process according to claim 7, wherein step (iv) is carried out at a temperature of 100-120° C. over a period of 10 seconds to 1 minute.

9. A process according to claim 7, wherein the lacquer is applied at a roll speed of 0.2-4 m/s in a thickness of the layer of 10-100 μm.

10. A process according to claim 7, wherein a the lacquer or electroresist comprising a laser structurable solder stop lacquer and electroresist wherein the solder stop lacquer or the electroresist has a solid content of 50-100 wt.-% and a viscosity of 5000-15000 mPas is used as the solder stop lacquer or the electroresist.

11. Laser structurable solder stop lacquer and electroresist, wherein the solder stop lacquer or the electroresist has a solid content of 50-100 wt.-% and a viscosity of 5000-15000 mPas.

12. Solder stop lacquer and electroresist according to claim 12, which is essentially free of fillers.

13. A solder stop lacquer and an electroresist according to claim 11, which is thermally curable or curable by irradiation.

14. A solder stop lacquer and an electroresist according to claims 11, which is halogen-free.

15. A solder stop lacquer and an electroresist according to claim 11, wherein the lacquer has a content of solvents having a boiling point above 120° C. of 5-20 wt.-%.

16. A solder stop lacquer and an electroresist according to claim 11, which comprises a halogen-free epoxy resin.

17. A solder stop lacquer and an electroresist according to claim 11, wherein the solder stop lacquer is a thermally curable, powdery solder stop lacquer having a viscosity of 10000- 15000 mPas at a temperature of 80-120° C.

18. Printed circuit board obtainable using the process according to claim 7.

19. An apparatus according to claim 4, wherein the metering rolls (5, 9) are heatable.

20. An apparatus according to claim 5, wherein the second metering roll (9) is a fixed metering roll being coated with a plastic film in such a way that the desired coating areas can be set free by peeling off the film.

21. A solder stop lacquer and an electroresist according to claim 12, which is thermally curable or curable by irradiation.

22. A solder stop lacquer and an electroresist according to claims 12, which is halogen-free.

23. A solder stop lacquer and an electroresist according to claims 13, which is halogen-free.

24. A process according to claim 7, wherein the lacquer is applied at a roll speed of 0.5-4 m/s in a thickness of the layer of 10-100 μm.

25. A process according to claim 7, wherein the lacquer is applied at a roll speed of 1-4 m/s in a thickness of the layer of 10-100 μm.
